(19) United States
(12) Patent Application Publication
(10) Pub. No.: US 2022/0240483 A1
(43) Pub. Date: Aug. 4, 2022

(54) ANIMAL BED

(71) Applicant: JACK & DAVID, LLC, Brentwood, MO (US)

(72) Inventor: Janet Otten, Brentwood, MO (US)

(21) Appl. No.: 17/665,158

(22) Filed: Feb. 4, 2022

Related U.S. Application Data
(60) Provisional application No. 63/145,904, filed on Feb. 4, 2021.

(51) Int. Cl. A01K 1/035; A47C 27/06; A47C 31/00

(52) U.S. Cl. CPC A01K 1/0353; A47C 31/007; A47C 27/06

(57) ABSTRACT

Animal bed system that includes an odor-absorbing compartment. The animal bed itself may be made from springs, which construction may allow for the easy storage of odor-absorbing materials inside of the bed frame, as well as provide for sufficient airflow. The animal bed system may further include sheets having holes therein to facilitate access to the animal bed. Further, the animal bed may include removable bolsters or other support portions.

### CROSS REFERENCE TO RELATED APPLICATIONS

This application claims benefit of U.S. Provisional Patent Application No. 63/145,904, filed Feb. 4, 2020, the entire disclosure of which is herein incorporated by reference.

### BACKGROUND OF THE INVENTION

Humans and animals have cohabitated for thousands of years. Today, animals share homes with many people. Like humans, animals typically require considerable rest. Animals have made beds in and around human settlements for as long as there has been domestication of animals. These beds began their existence much like the beds of domesticated animals' ancestors: beds of straw, leaves, or other natural material. At the time, human bedding was not much different. However, over time, the conditions for both humans and domesticated animals have improved. This has led to more comfortable bedding for both humans and animals.

Unfortunately, even though animal bedding has made many advances over the years, animal bedding lags behind human bedding by a considerable margin. Current animal beds typically use inferior cushion technologies and do not address several issues associated with maintaining animals' beds.

Animals' beds are typically formed out of foam material or a stuffing material (natural or synthetic) and a cover or container for the filler material. Foam and stuffing tend to bunch together, creating uncomfortable inconsistencies in the support offered over the surface of the bedding. Further, such materials may absorb and hold odors. Moreover, such beds are often difficult to maintain. Many are not washable or, if they are, the entire bed must be washed. This is typically due to the construction of animal beds, which typically have an outer covering that is not removable. Thus, the cover and interior contents must all be washed. This may pose logistical complications because the beds may be large and difficult to machine launder. Further, it may be difficult to properly wash and dry the inner foam or stuffing. Some animal beds attempt to address these issues with a removable cover. However, this cover is often difficult to remove and replace, and even washing the cover does not address the problem of soiled/dirty/smelly foam or stuffing material. Accordingly, there is a need in the art for an improved animal bed.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is an improved animal bed. At a high level of generality, the animal beds described herein may use a novel coil spring cushion having a construction that is suitable for an animal but also allows for the use and maintenance of odor-absorbing or mitigating material. Further, the animal beds described here may allow for the animal beds to use conveniently removed and replaced sheets, as well as various means of carrying the animal bed itself.

Described herein, among other things, is an animal bed system, the system comprising: a bed including a frame and a plurality of coils; wherein the bed includes at least one compartment that passes through the exterior cover, such that the interior of the compartment is accessible from the exterior of the bed.

In an embodiment of the animal bed system, bed further comprises an exterior covering, and the at least one compartment is accessible through the exterior covering.

In an embodiment of the animal bed system, the compartment further comprises a support portion and a carrier portion, wherein the support portion is attached to said exterior cover, and wherein the carrier portion is configured to hold a bag at least partially inside of the bed.

In an embodiment of the animal bed system, the attachment between the support portion and the exterior cover is a removable attachment.

In an embodiment of the animal bed system, the carrier portion further comprises a spring.

In an embodiment of the animal bed system, the carrier portion comprises a plastic container having holes therein.

In an embodiment of the animal bed system, the system further comprises a sheet configured to cover at least a portion of the bed.

In an embodiment of the animal bed system, the bed has a shape like a rectangular prism and having six sides, and the sheet is configured to cover at least five sides of the six sides of the bed.

In an embodiment of the animal bed system, the sheet has at least one sheet opening, wherein the exterior covering has one or more handles, and wherein said at least one sheet opening is configured to allows access to at least one of the one or more the handles.

In an embodiment of the animal bed system, the sheet has at least one sheet opening, and wherein the at least one sheet opening is configured to allows access to the at least one compartment.

In an embodiment of the animal bed system, the bag is configured to hold odor-absorbing material.

In an embodiment of the animal bed system, the odor-absorbing material comprises carbon.

In an embodiment of the animal bed system, the odor-absorbing material comprises charcoal.

In an embodiment of the animal bed system, the coils have an hourglass shape, which shape has bulges at each end, and wherein said compartment is formed between the bulges of adjacent coils.

### BRIEF DESCRIPTION OF THE DRAWINGS

FIG. 1 depicts a side view of an animal bed in accordance with this application.

FIG. 2 depicts a top perspective view of the animal bed depicted in FIG. 1.

FIG. 3 depicts another top perspective view of the animal bed depicted in FIG. 1.

FIG. 4 depicts yet another top perspective view of the animal bed depicted in FIG. 1.

FIG. 5 depicts a bottom view of the animal bed depicted in FIG. 1.

FIG. 6 depicts a cross-sectional view of the animal bed depicted in FIG. 1.

FIG. 7 depicts a perspective close-up view of an embodiment of a frame of an animal bed in accordance with this application.

FIG. 8 depicts a perspective view of the embodiment of the frame of the animal bed depicted in FIG. 1.

FIG. 9 depicts another perspective close-up view of the embodiment of the frame of the animal bed depicted in FIG. 1.

FIG. 10 depicts a side view of the embodiment of the frame of the animal bed depicted in FIG. 1.

FIG. 11 depicts a top view of the embodiment of the frame of the animal bed depicted in FIG. 1.

FIG. 12 depicts yet another perspective close-up view of the embodiment of the frame of the animal bed depicted in FIG. 1.

FIG. 13 depicts a top close-up view of another embodiment of an animal bed in accordance with this application.

FIG. 14 depicts a close up view of another embodiment of an animal bed having a lateral odor-absorbing compartment.

FIG. 15 depicts a top view of the animal bed of FIG. 14.

FIG. 16 depicts a side view of the animal bed of FIG. 14.

FIG. 17 depicts a close up of a bag for holding material in accordance with this application.

FIG. 18 depicts a top view of the animal bed of FIG. 14 having a bag therein.

FIG. 19 depicts a side view of the animal bed of FIG. 14 having a bag therein.

FIG. 20 depicts a side view of the animal bed of FIG. 14 having a bag therein and including a first padding layer.

FIG. 21 depicts a side view of the animal bed of FIG. 14 having a bag therein and including a second padding layer.

FIG. 22 depicts a side view of the animal bed of FIG. 14 having an exterior covering.

FIG. 23 depicts a side view of the animal bed of FIG. 14 having a sheet thereon.

FIG. 24 depicts a bottom view of the animal bed of FIG. 14 having a sheet thereon.

FIG. 25 depicts a top perspective view of an embodiment of an animal bed including bolsters attached thereto.

FIG. 26 depicts a close up view of a buckle of the embodiment of an animal bed of FIG. 25.

FIG. 27 depicts a close up view of two buckles of the embodiment of an animal bed of FIG. 25.

FIG. 28 depicts a view of the animal bed of FIG. 25 having a sheet thereon.

FIG. 29 depicts an additional view of the animal bed of FIG. 25 having a sheet thereon.

### DETAILED DESCRIPTION OF THE EMBODIMENT(S)

This disclosure generally relates to bedding, and more particularly to bedding intended for use by animals. Although this application will discuss various embodiments of the inventions herein in terms of an animal bed, the devices, methods, systems, or other inventions disclosed herein are applicable to any bed or other cushioning device intended to be or capable of providing support to a user, especially those which may require odor absorbing capabilities. Such a user may be any animal, including a human.

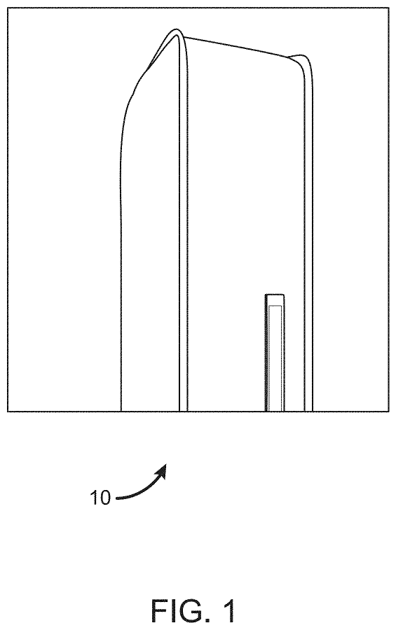

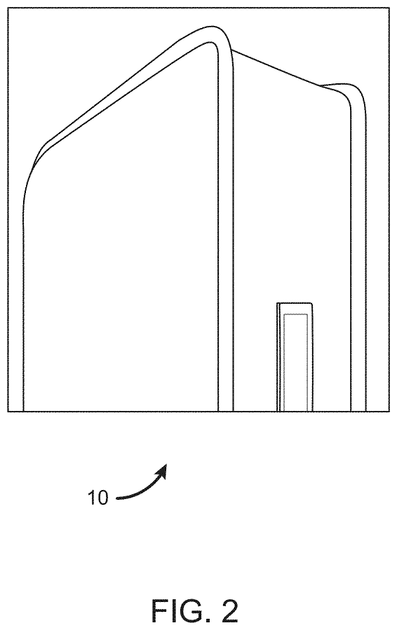

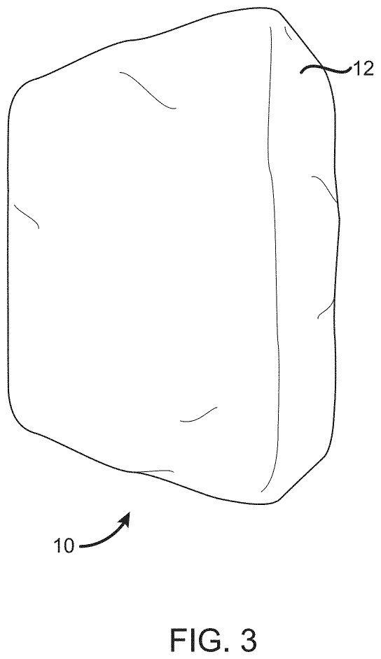

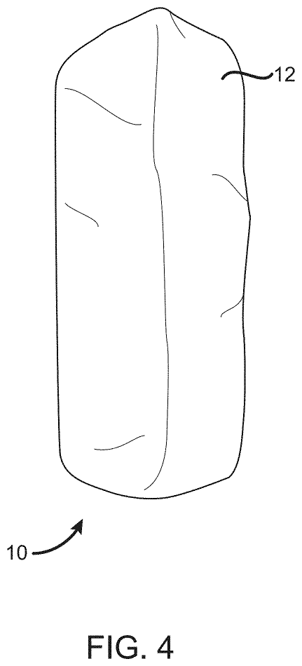

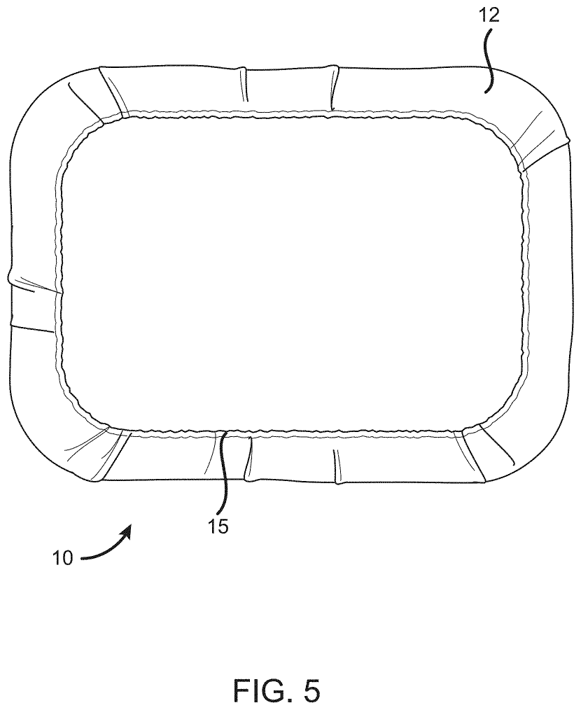

FIGS. 1 through 7 depict an embodiment of an animal bed (10) in accordance with this application. FIGS. 1 and 2 depict the overall construction of an embodiment of an animal bed (10), similar to that of a modern mattress intended for use by humans. In the depicted embodiment, the animal bed (10) has an internal frame and an exterior cover, which cover is visible in FIGS. 1 and 2. FIGS. 3 and 4 show that the animal bed (10) may be covered by a sheet (12). FIG. 5 shows more detail about the relationship between the sheet (12) and the animal bed (10), which bed may have six surfaces and a shape like a rectangular prism. Specifically, in the depicted embodiment, the sheet (12) may wrap around five of the six surfaces of the animal bed (10). The sixth side of the animal bed (10) may be partially covered by the sheet (12), as depicted in FIG. 5. In other embodiments, the animal bed (10) may have any shape or number of surfaces as long as the animal bed (10) may provide a relatively comfortable surface and related support for someone or something resting on the animal bed (10). The sheet (12) may use any system known to persons of ordinary skill in the art to maintain its position relative to the bed (10). In the embodiment depicted in FIG. 5, the sheet (12) includes an elastic portion (15) that assists in maintaining the sheet's (12) position relative to the bed (10). The elastic portion (15) maintains tension on the sheet (12) so that the sheet (12) may not slip off of the bed (10). The sheet (12) may be made of any material suitable for a sheet (12).

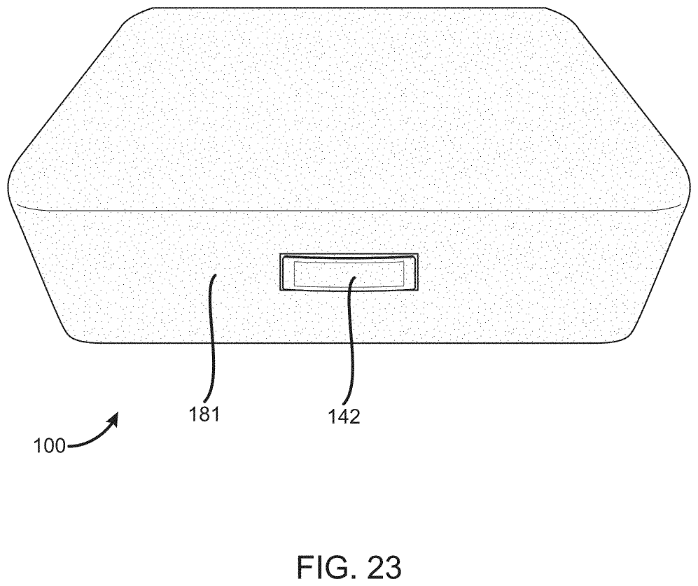

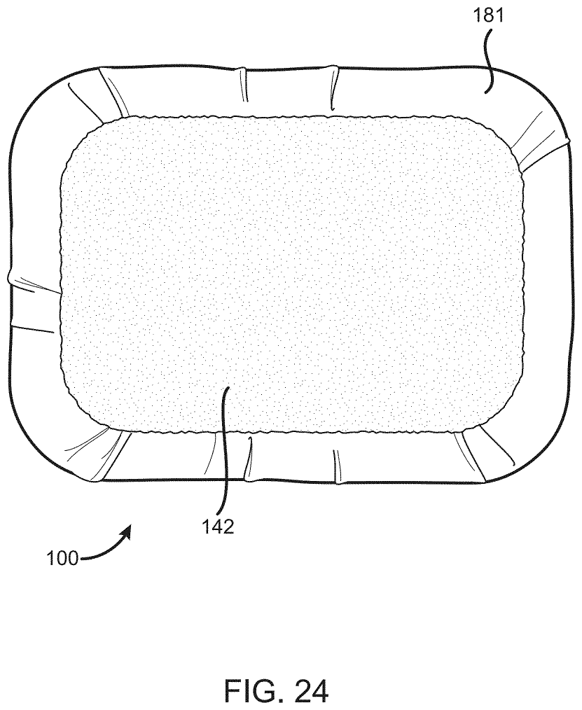

FIGS. 23 and 24 show side and bottom views of another embodiment of a sheet (181) in accordance with this application. In this embodiment, the sheet (181) may have a construction just the sheet (12), discussed above. In addition, the sheet (181) may have one or more openings within the sheet, as shown in FIG. 23, that allow for easy access to the material under the sheet (181). For example, and as shown in FIG. 23, the animal bed (100) may have one or more handles that may be accessed through one or more openings in the sheet (181). The holes in the sheet (181) may be sized and arranged to line up with and accommodate these handles attached to the animal bed (100). Similarly, the openings in the sheet (181) may be used to access other portions of the animal bed (181), such a lateral odor-absorbing compartment (132), discussed in detail below.

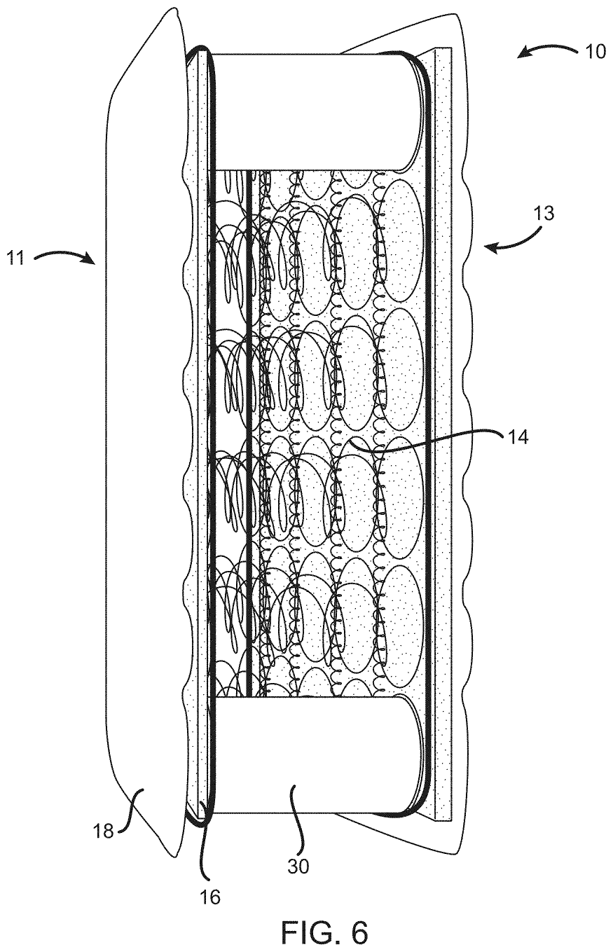

FIG. 6 shows a cross-sectional view of the interior of the animal bed (10) depicted in FIGS. 1 through 5 discussed above. On the inner most portion of the animal bed (10) is a frame (14) including plurality of coils (22). Around or over the frame (14) is a first padding layer (16). Around or over the first padding layer (16) is the second padding layer (18). Also shown in FIG. 6 is an odor-absorbing compartment (30) formed around and including at least one coil of the plurality of coils (22) of the frame (14). In an embodiment, the odor-absorbing compartment (30) may be sized and shaped to accommodate bags or other containers of odor-absorbing or mitigating material to assist with reducing odor for the animal bed (10). In other embodiments, the odor-absorbing compartments (30) may have any shape or size, which may be configured based on the intended use. In other embodiments, any padding construction may be used. The odor-absorbing compartment (30) is not typically itself odor-absorbing, but, instead, is intended to hold something, such as odor-absorbing material.

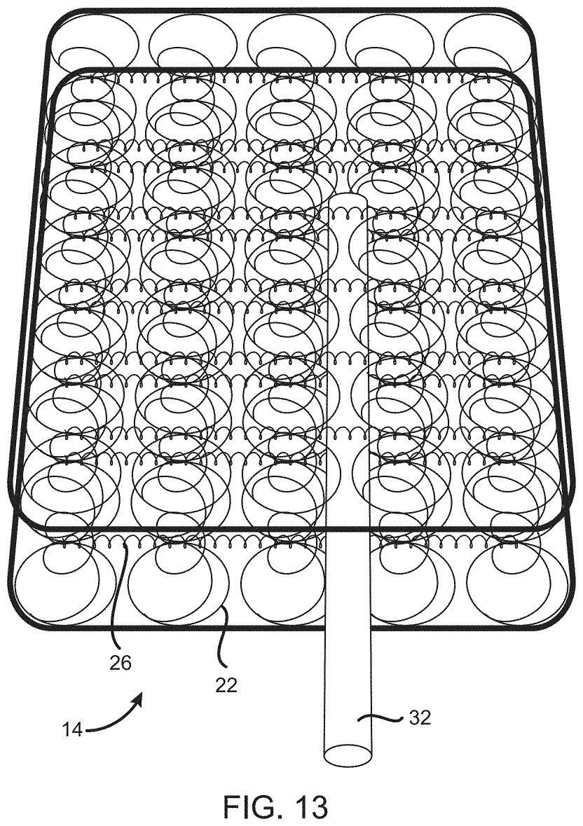

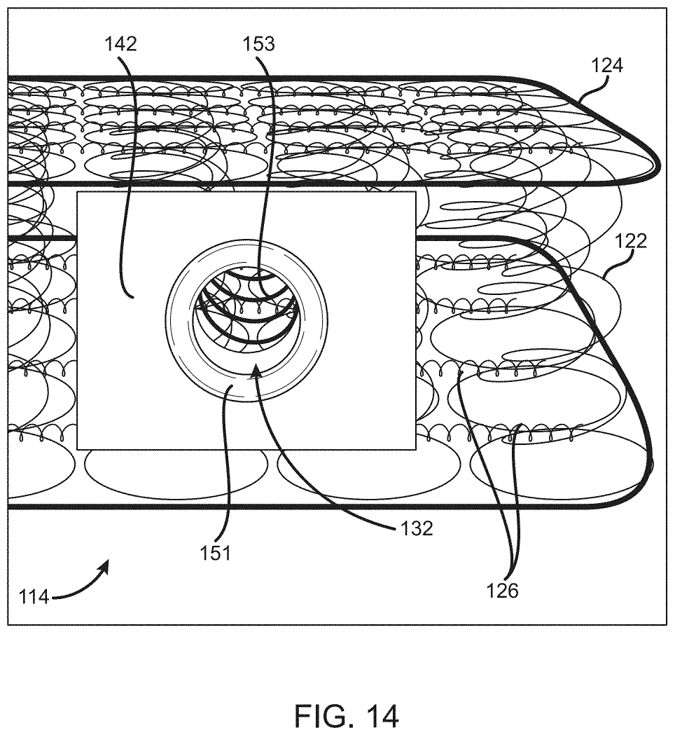

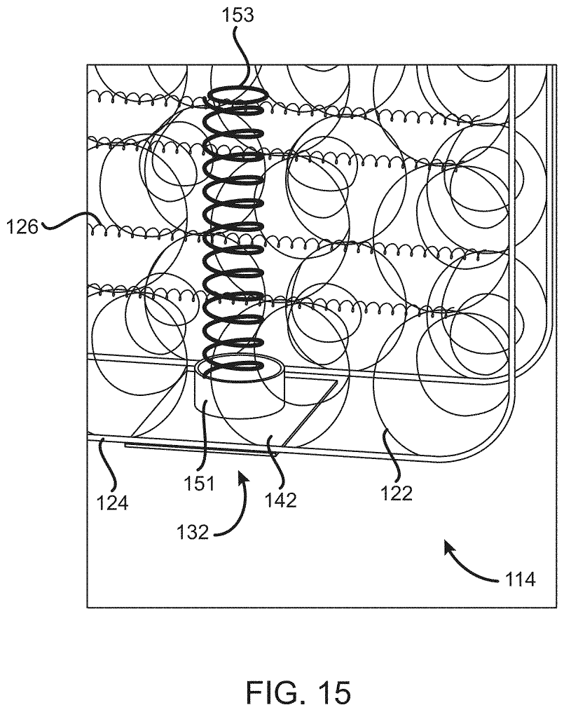

The odor-absorbing compartment (30) may be positioned in any manner. For example, in some embodiments, the odor-absorbing compartment may be oriented as shown in FIG. 13, as shown in FIGS. 14 and 15 (lateral odor-absorbing compartment (132)), or otherwise oriented, as would be understood by a person of ordinary skill in the art. Further, as would be appreciated by a person of ordinary skill in the art, the odor-absorbing compartments (30) may be used to carry odor-absorbing material, or any other material able to be carried by the odor-absorbing compartment (30).

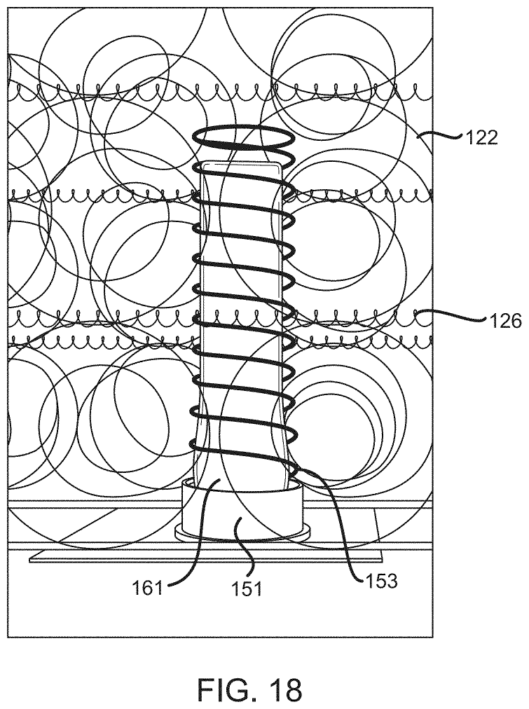

In the embodiment depicted in FIG. 6, the top (11) of the animal bed (10) is identical to the bottom (13) of the animal bed (10). In other embodiments, the top (11) may be different from the bottom (13). For example, the top (11) may have more or less layers than exist in the bottom (13). FIG. 18 shows an exemplary embodiment wherein one side has thicker first padding layer (163) on the frame (114) than the other side. Further, the sides of the animal bed (10) may have the same construction as either the top (11) or the bottom (13). In other embodiments, the sides of the animal bed (10) may have a construction that differs from both the top (11) and the bottom (13).

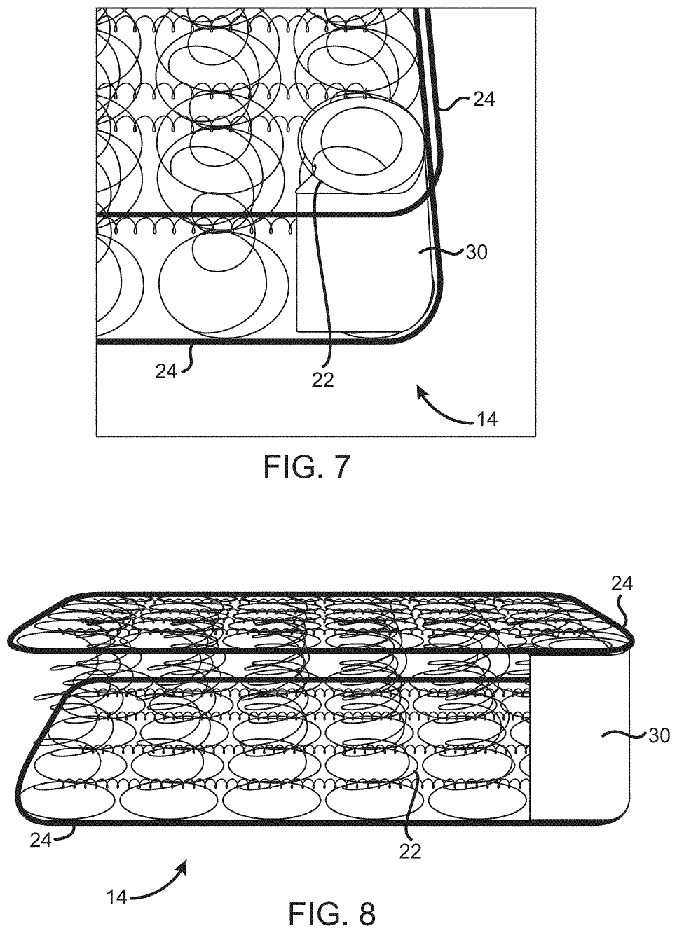

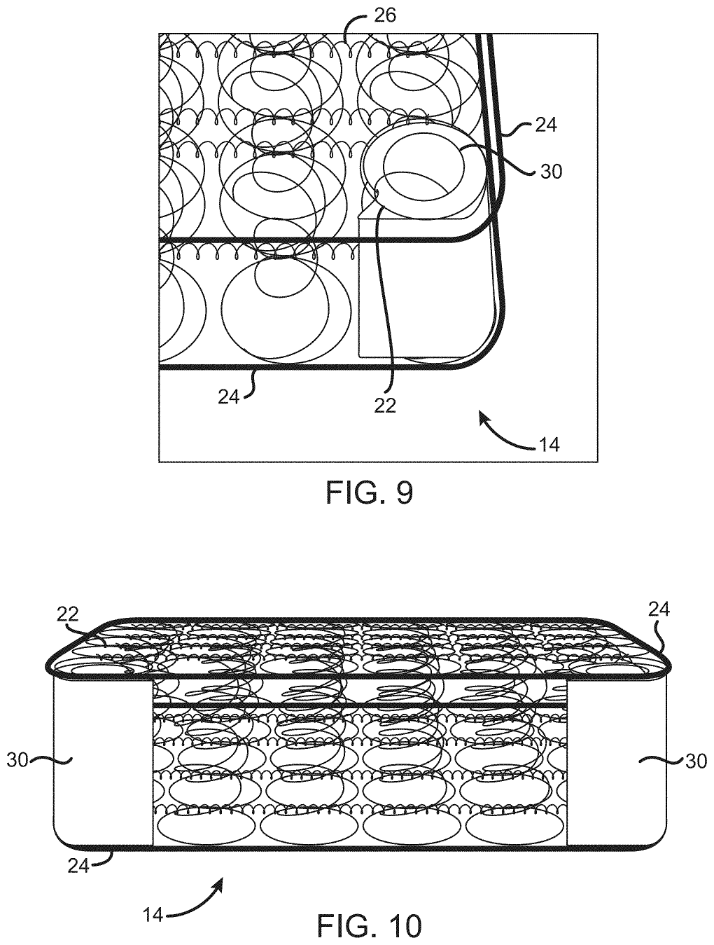

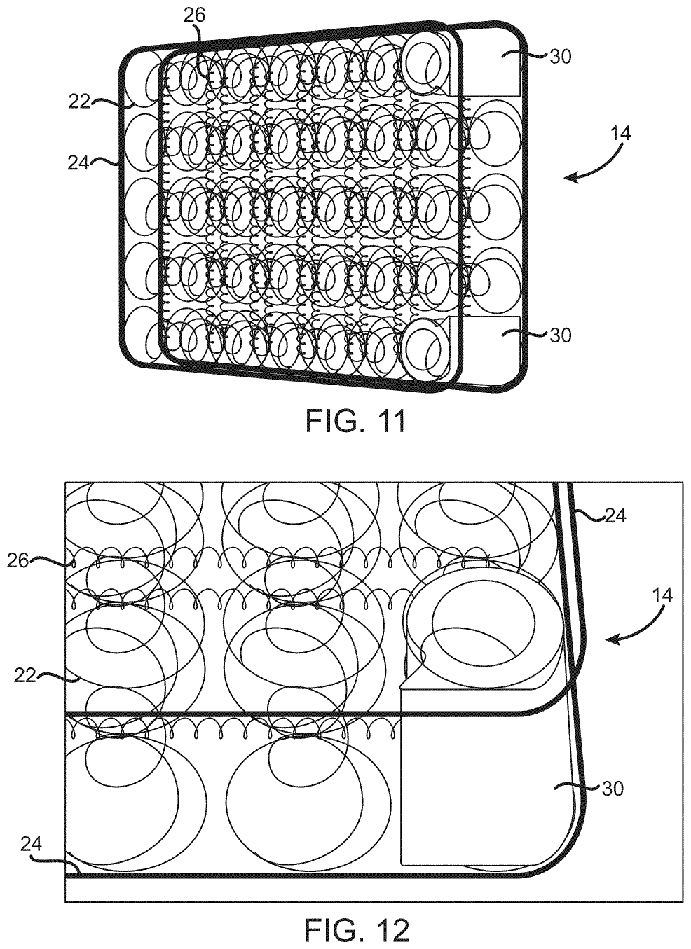

FIGS. 7 through 13 show further details of the frame (14) of the animal bed (10) shown in FIGS. 1 through 6. In the depicted embodiment, the frame (14) may include the plurality of coils (22); one or more binding portions (24); one or more binding springs (26); and one or more odor-absorbing compartments (30). Here, the plurality of coils (22) are typically included to provide a supportive surface that may yield somewhat under pressure. The arrangement of the coils is typically as shown in FIGS. 7 through 13. Specifically, the coils (22) may typically be arranged in columns and rows. This may allow for the ability of the frame (14) to yield in different amounts across the top (11) of the animal bed (10), providing a comfortable experience to the user of the animal bed (10). The binding portions (24) and the binding springs (26) may typically be used to restrict lateral or otherwise undesired movement of the plurality of coils (22).

The coils (22) themselves, and their related constructions, may be any coils (22) known to a person of ordinary skill in the art. In some embodiments, the coils (22) may be similar to those in a bonnell spring mattress system. A bonnell spring mattress system typically has coils having an hourglass shape (wider at the bottom and the top than the middle) and are interconnected with a mesh of metal (or otherwise interconnected) to make the spring system. Accordingly, the coils (22) in the depicted embodiment typically have an hourglass shape, as shown in FIGS. 7 through 13. Further, the mesh may be comprised of the binding portions (24) and the binding springs (26). The binding springs (26) may be any springs. In some embodiments, they may have a round helical shape, and each may connect one or more adjacent coils. The binding portions (24) may have any construction. In some embodiments, the binding portions (24) may be made from cylindrical wires having about a 4 mm diameter, although any diameter may be used. Clips or other binding devices may be used to attach some of the coils to the binding portions (24).

The animal bed (10) may have any shape and size but is generally sized and shaped to ergonomically accommodate an animal of a particular size in a resting or sleeping position. In some embodiments, the shape of the animal bed (10) will be generally similar to a rectangular prism. Further, the size of the animal bed (10) may vary depending on application. There may be a variety of sizes used for different animals or applications. Such sizes may be, for example, small, medium, large, or extra-large.

The odor-absorbing compartments (30) may be included in any arrangement, as would be understood by a person of ordinary skill in the art. The odor-absorbing compartments (30) may be configured to retain something inside—typically an odor-absorbing or mitigating material along with a suitable bag or container for that material. The odor-absorbing compartments (30) may be made of any material or combination of materials capable of retaining something. In an embodiment, the odor-absorbing compartments (30) may be made of a foam material. In other embodiments, the material of the odor-absorbing compartment (30) may be a material that is gas permeable, which may better promote odor mitigation. In some embodiments, an odor-absorbing compartment (30) may be arranged to envelope at least a part of a coil of the plurality of coils (22). An odor-absorbing compartment (30) may also be arranged to envelope at least a part of the space around a given coil or coils (22). This may allow the odor-absorbing compartment (30) to provide additional support to the animal bed (10), especially when used on the corners or periphery of the animal bed (10). In such an embodiment, the odor-absorbing compartments (30) may not contain anything additional beyond other portions of the animal bed (10).

In some embodiments, an odor-absorbing compartment (30) may be configured to retain an odor-absorbing or otherwise mitigating material, such as carbon, activated carbon, charcoal, or bamboo charcoal. However, any odor-absorbing or otherwise mitigating material or combination of materials may be used. In some embodiments, the odor-absorbing or otherwise mitigating material or combination of materials may be arrange in a separate bag or container, which bag may be made of any material, including burlap. One or more odor-absorbing compartments (30) may be included within the frame (14). For example, one odor-absorbing compartment (30) may be included in or around coils (22) in each of the four corners of a generally rectangular frame (14). In other embodiments, odor-absorbing compartments (30) may be arranged in any manner within the frame (14).

FIG. 13 shows a different embodiment of the frame (14), which embodiment includes a lateral odor-absorbing compartment (32). The lateral odor-absorbing compartment (32) may be located anywhere at least partially within the frame (14). In some embodiments, the lateral odor-absorbing compartment (32) may be located between coils of the plurality of coils (22) as shown in FIG. 13. The lateral odor-absorbing compartment (32) may extend though the frame (14). In other embodiments, the lateral odor-absorbing compartment (32) may extend only partially into the frame (14). For example, in an embodiment, the lateral odor-absorbing compartment (32) may extend about 18 inches (or between about 6 and about 8 inches) into the frame (14), and may have a diameter between about 1 inch and about 3 inches, preferably between about 1.25 inches and about 2 inches.

The lateral odor-absorbing compartments (32) may be configured to retain something inside. The lateral odor-absorbing compartments (32) may be made of any material or combination of materials capable of retaining something. In an embodiment, the lateral odor-absorbing compartments (32) maybe made of a foam material. In other embodiments, the lateral odor-absorbing compartments (32) may be made from a tube. In yet other embodiments, the lateral odor-absorbing compartments (32) may be made from a spring. The lateral odor-absorbing compartments (32) may be permeable to gas, which may better promote odor mitigation. For example, the odor-absorbing compartments (32) may comprise a plastic container having holes therein. In some embodiments, a lateral odor-absorbing compartment (32) may be arranged to envelope at least a part of a coil of the plurality of coils (22). A lateral odor-absorbing compartment (32) may also be arranged to envelope at least a part of the space around a given coil or coils (22). In some embodiments, a lateral odor-absorbing compartment (32) may be configured to retain an odor-absorbing or otherwise mitigating material, such as carbon, activated carbon, or charcoal. However, any odor-absorbing or otherwise mitigating material or combination of materials may be used. In some embodiments, the odor-absorbing or otherwise mitigating material or combination of materials may be arranged in a separate bag (or any other container).

An example of using a lateral odor-absorbing compartment (32) will now be described. First, the user may acquire an animal bed (10). Then, the user may ensure that nothing is currently in the lateral odor-absorbing compartment (32) and that nothing is obstructing access to the lateral odor-absorbing compartment (32). Typically, the lateral odor-absorbing compartment (32) will extend up to the outermost edge of the animal bed (10), so that a user may access the lateral odor-absorbing compartment (32) from a side surface of the animal bed (10). In such an embodiment, the animal bed (10) will typically have an opening formed in all layers so that a user may directly access the interior volume of the lateral odor-absorbing compartment (32). In some embodiment, the lateral odor-absorbing compartment (32) will rest on the bottom side of the frame (14). In other embodiments, the lateral odor-absorbing compartment (32) may be arranged at any position between the largest surfaces (the top and bottom surfaces) of the animal bed (10).

The user may then access the interior volume of the lateral odor-absorbing compartment (32). This may allow the user to place a bag or container of odor-absorbing or mitigating material into the lateral odor-absorbing compartment (32) from the exterior of the animal bed (10). Further, this should allow the user to access the bag or container of odor-absorbing or mitigating material in order to remove, replace, or maintain the material therein. Thus, sufficient odor mitigation may be maintained throughout the life of the animal bed (10).

In typical embodiments, any odor-absorbing or otherwise mitigating material or combination of materials may be removable by the user. Typically, the material will rest within the odor-absorbing compartment (30) or the lateral odor-absorbing compartment (32), and the material will be maintained in that position by gravity and the strength of the material used to form the given compartment. In other embodiments, the material and its bag or container may be fastened into the given compartment using any means known in the art. The ends of either of the odor-absorbing compartment (30) or the lateral odor-absorbing compartment (32) may be closeable to assist in retaining material. This closure may be openable. Further, either of the odor-absorbing compartment (30) or the lateral odor-absorbing compartment (32) may use any fastening system to keep the given compartment in position within the frame (14). In some embodiments, the fastening system may include hooks or clamps so that the odor-absorbing compartment (30) or the lateral odor-absorbing compartment (32) may be attached to an adjacent coil or binding portion (24).

In some embodiments, the first padding layer (16) or second padding layer (18) may include one or more openings to allow user access to the odor-absorbing compartment (30) or the lateral odor-absorbing compartment (32). This may facilitate replacement of the material placed therein. Such an opening may include a grommet, or other device, that allows for easy and repeatable access though the opening. The opening may be closeable. In some embodiments, a cap or other closure mechanism may be used. In other embodiments, the first padding layer (16), second padding layer (18), sheet (12), or other material may be used to affect closure, for example, by using a zipper, a drawstring, or the like.

The first padding layer (16) or second padding layer (18) may be made of any material or combination of materials. In some embodiments, the first padding layer (16) or second padding layer (18) may include a canvas material. In other embodiments, the first padding layer (16) or second padding layer (18) may include a waterproof or water-resistant material. The first padding layer (16) may include a needle punched wool material, which may serve as a barrier pad and insulator material. Such a material is relatively strong and dense, which may provide some structure to the animal bed (10) while assisting to more evenly spread out pressure. Further, this material may assist in preventing unwanted materials from entering the frame (14). The second padding layer (18) may include cushioning materials, such as foam or cotton layers. Such materials may provide comfort to an animal using the animal bed (10). The second padding layer (18) may include a waterproof or water-resistant material, which material may also be tear and puncture resistant. This material may also be breathable, and may be a canvas material.

In some embodiments, the animal bed (10) may have one or more handles around the sides of the animal bed (10), which handles may allow for carrying of the animal bed (10). In such an embodiment, the related sheet (12) may have openings to accommodate passage through the handles. Such openings are not provided on prior sheets. This may be because human beds are typically too large to conveniently carry. Additionally, and perhaps because human beds are heavier, human beds are not typically moved frequently. On the other hand, typical animal beds may be smaller and more portable than human beds. Further, people tend to move animal beds more frequently than human beds are moved.

Further, the use of springs within the frame (14) may allow for airflow in and around the animal bed (10), which may help reduce odor retention and help an animal resting on the animal bed (10) maintain a comfortable body temperature. The animal bed (10) may be hypoallergenic in order to provide a comfortable space for an animal, while also preventing humans who handle the animal bed (10) or are otherwise proximate to the animal bed (10) from having allergic reactions due to the animal bed (10). At least some portions of the animal bed (10) may be recyclable, which feature may make the animal bed (10) more environmentally friendly.

Another embodiment of an animal bed (100) is shown in FIGS. 14 through 24. FIG. 14 shows an animal bed (100) having a frame (114) and a lateral odor-absorbing compartment (132) placed therein. In the depicted embodiment, the frame (114) may include a plurality of coils (122); one or more binding springs (126); and one or more binding portions (124). Each component of the animal bed (100) may have a construction similar to those discussed above with respect to other embodiments. The lateral odor-absorbing compartment (132), in this embodiment, may include a support portion (151) and a carrier portion (153). As shown in FIG. 14, the odor-absorbing compartment may be mounted to, or in, the bed (100) by a connection between the support portion (151) and the covering or padding of the bed (100), in this case, an exterior covering (142). The exterior covering (142) may be formed from one or more sections of material. Typically, the exterior covering (142) surrounds or envelops the entire frame (114). However, in some embodiments, less than the entire frame (114) may be surrounded or enveloped. In some embodiments, for example, five of the six sides of a rectangular prism-shaped animal bed (100) are covered.

As discussed above, the carrier portion (153) may be made of many different materials, including a spring or a plastic piece with holes therein. In embodiments where the carrier portion (153) is made of a spring, several potential advantages may be had, at least in some contexts. For example, when the carrier portion (153) is a spring, the carrier portion (153) typically extends into the frame (114) between adjacent coils (122). The orientation of the odor-absorbing compartment (132), and of the carrier portion (153), is typically perpendicular to the length (and main compression direction) of the coils (122). Because the coils (122) are typically hourglass-shaped, the carrier portion (153) typically is located around the narrow portion of the hourglass shape. This orientation and construction may have the benefit that it masks, or smooths, the perception of any material being within the animal bed (100) when mass is added to the animal bed. This may be due to the fact that as mass is added, the coils will compress, and possible compress nonuniformly. The flexible nature of some embodiments of the carrier portion (153) may allow for the mass of the carrier portion (153) to not be felt by the mass sitting on the animal bed (153). The flexibility of the carrier portion (153) and its ability to move while in between the coils (122) may provide these and similar advantages, at least in some embodiments. Further, the use of a bag to hold the odor-absorbing material may be beneficial in that it may make removing and replenishing odor-absorbing material easier while remaining flexible and moveable. This flexibility may assist in comfort, similar to a spring carrier portion (153).

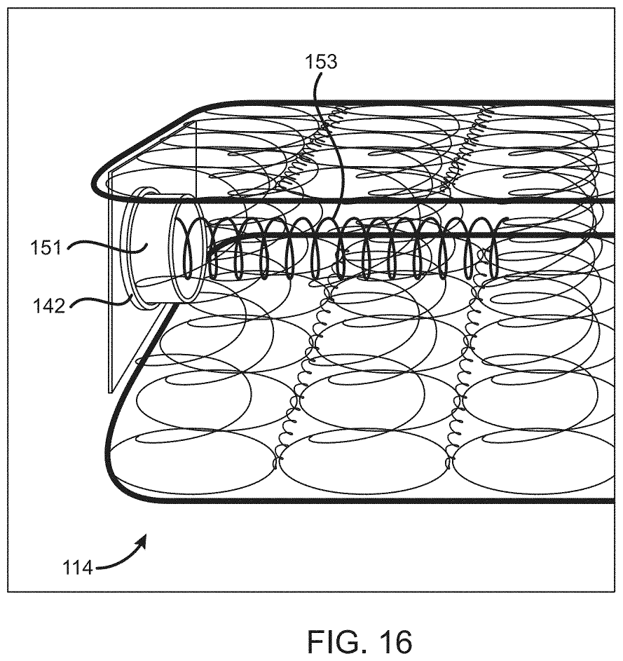

As shown in FIG. 15, the lateral odor-absorbing compartment (132) may extend into the frame (114) between the coils (122). In the depicted embodiment, the support portion (151) and the carrier portion (153) each at least partially extend into the frame (114). In the depicted embodiment, the support portion (151) is connected to the exterior covering (142) via an o-ring. As depicted, the lateral odor-absorbing compartment (132) is suspended above the bottom of the frame (114) and below the top of the frame (114). FIG. 16 shows a close up side view of the lateral odor-absorbing compartment (132) within the frame (114).

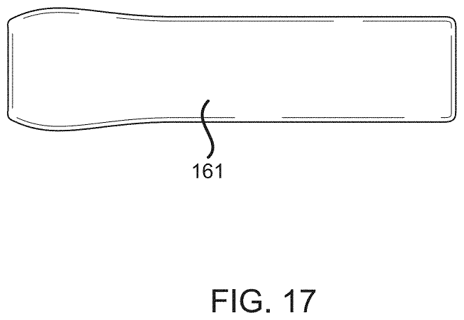

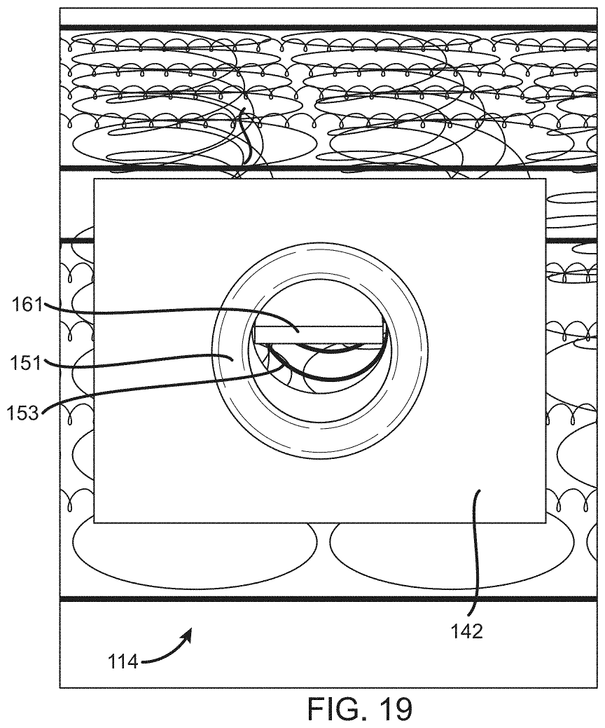

FIG. 17 shows an embodiment of a bag or container (161) for holding odor-absorbing material. The bag (161) is sized and shaped to be capable of being inserted into the lateral odor-absorbing compartment (132). The bag may have any construction, as is described above with reference to a bag for containing odor-absorbing or otherwise mitigating material or combination of materials. The bag (161) may be made of any material, including burlap, as long as the bag (161) is at least somewhat air permeable. FIGS. 18 and 19 show views of the bag (161) placed within the carrier portion (153) of the odor-absorbing compartment (132).

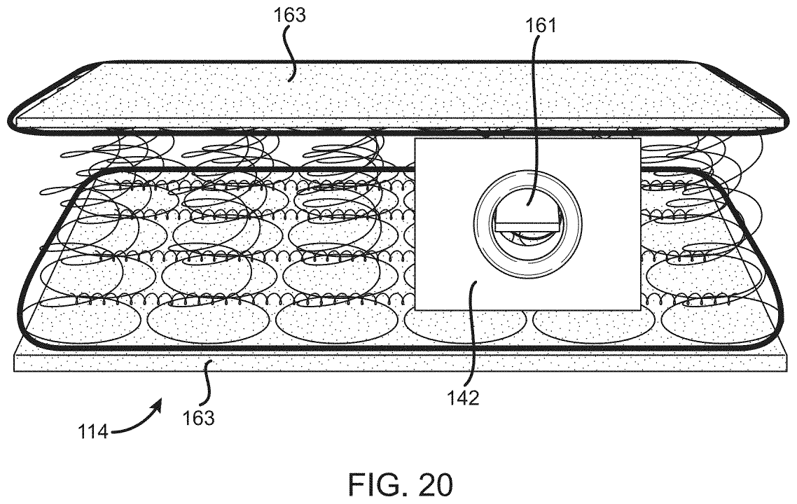

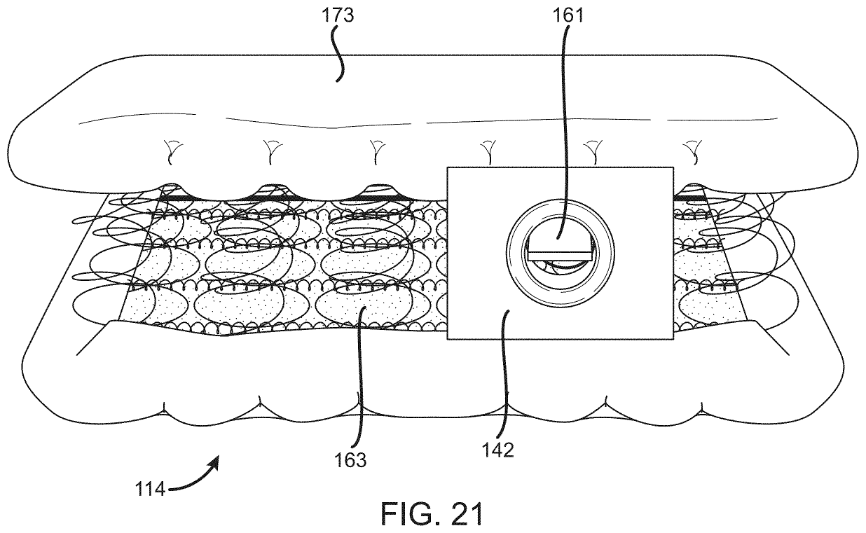

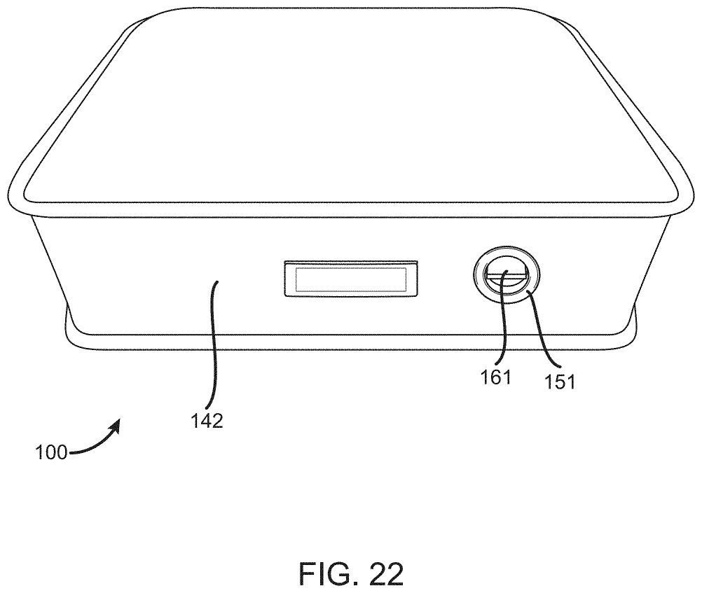

FIGS. 20 through 24 show details of the various layers that may provide cushion to a user of the bed (100) and protect (and provide support to) the frame (114). First, there is a first padding layer (163). As shown in FIG. 20, the first padding layer (163) may be placed across the top and the bottom of the frame (114). Further, as shown in FIG. 20, the first padding layer (163) on the top may be different that the first padding layer (163) on the bottom. In other embodiments, the top and bottom may be the same, at any thickness and made of any material. Such a material may be a felt or other matting material. As shown in FIG. 21, material may be placed over or around the first padding layer (163), such as a second padding layer (173). The second padding layer (173) may have any construction and may be made of any material. FIG. 22 shows some details of an exterior covering (142). This may be made of any material or materials, in any number of parts, and may have any construction. In the depicted embodiment, the exterior covering (142) is made of a mostly waterproof material. The lateral odor-absorbing compartment (132) is shown extending though the exterior covering (142) to allow access to the frame (114) interior. The support portion (151) is mounted to the exterior covering (142) or otherwise passes through, such that bags (161) may be placed into and taken out of the lateral odor-absorbing compartment (132).

FIGS. 23 and 24 show an animal bed (100) with an optional sheet (181) installed thereon. The sheet (181) will typically wrap around five of the six sides of the animal bed (100), and will typically remain in place by the constricting elastic formed around the edge of the sheet (181) as shown in FIG. 24. As discussed above, the sheet (181) may have one or more holes formed therein. These holes may be used to access portions of the animal bed (100), such as handles formed on the bed (100). In some embodiments, the handles may be formed on the exterior covering of the animal bed (100). The holes may have any orientation. In some embodiments, the holes may be formed in the areas of the sheet (181) intended to cover the sides of the animal bed (100), as shown in FIG. 23.

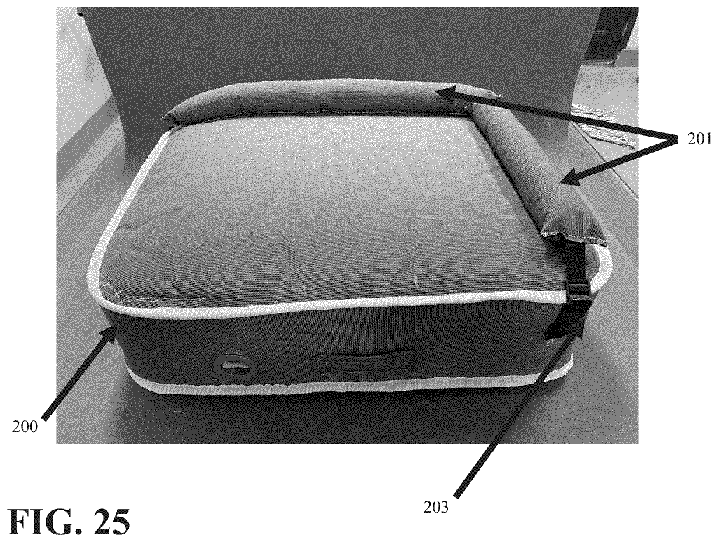

In some embodiments, bolsters or other supportive material (201) may be attached to an animal bed (200) to provide some support for the related animal. An example of bolsters (201) are shown in FIGS. 25 through 29 in use with an animal bed (200). Such bolsters (201) may also provide the animal with a cozy or guarded place to lay. Other bolsters are typical on prior foam and stuffing based animal beds. However, in prior animal beds, such bolsters are typically integrated into the bed. In this application, a bolster (201) may be added using a covering for the foam, stuffing, or other material of the bolster, which covering may attached to the animal bed (100) using elastic like the sheet (181) in FIGS. 23 and 24. In other embodiments, the bolster may attach to the animal bed using any attachment means, such as buckles, straps, hook-and-loop material, or any other fastener known to persons of ordinary skill in the art (203). An embodiment of such an attachment mean (203), specifically a buckle, is shown in FIGS. 25 through 29.

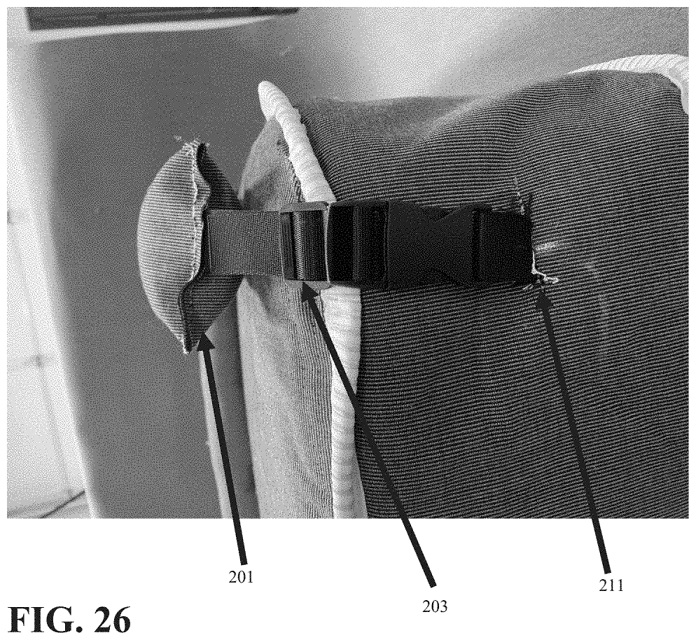

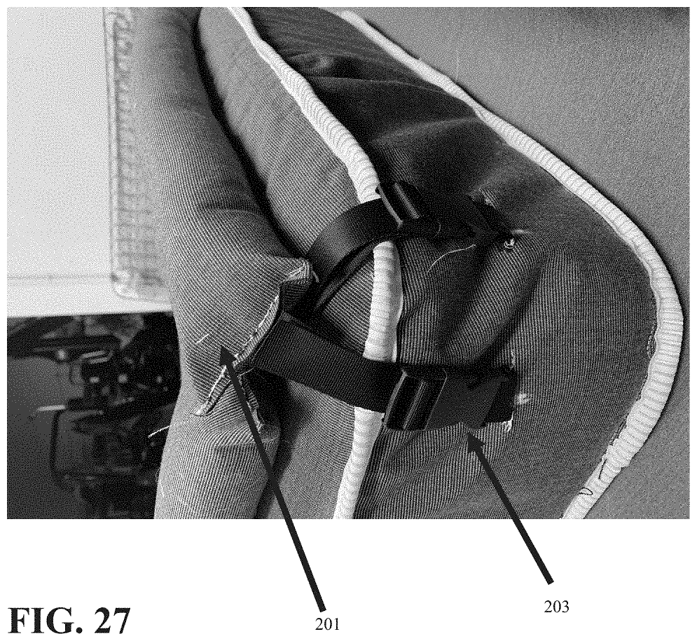

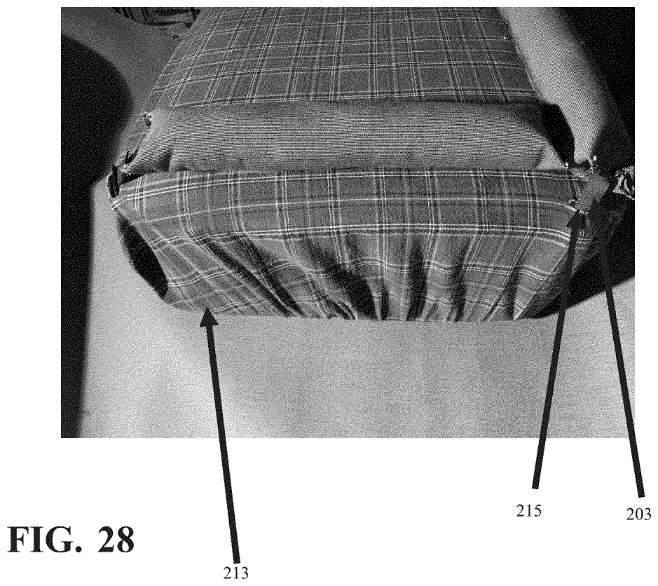

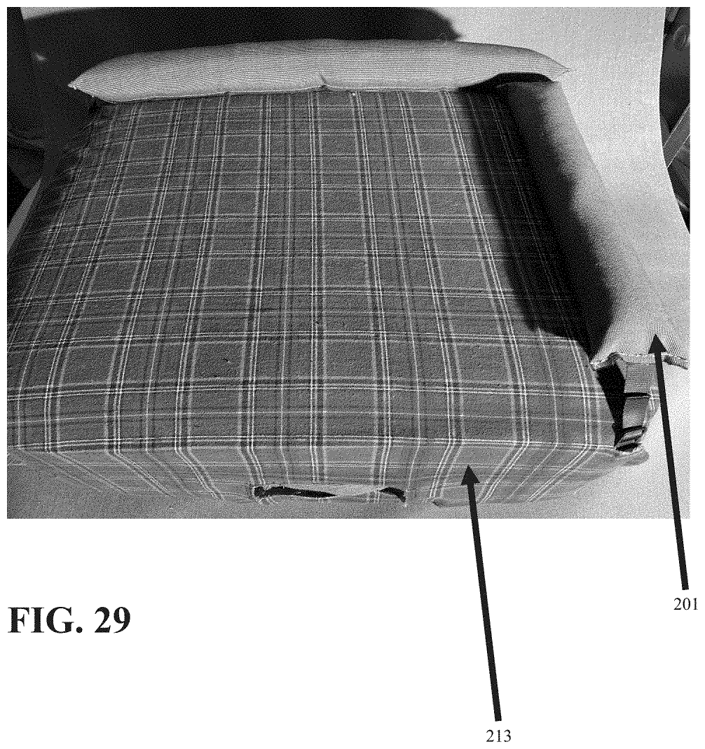

FIG. 25 shows an animal bed (200) including two bolsters (201), each of which is attached to the animal bed (200) via two buckles (203), one formed on either end of the bolster (201). Each buckle (203) is connected to one end of a given bolster (201). Between the buckle (203) and the bolster (201) is some attaching means, such as a length of nylon cord, webbing, or the like. FIG. 26 shows a close up view of a buckle (203). In the depicted embodiment, the buckle (203) may be attached to the animal bed (200) via a length of nylon cord, webbing, or the like, which length extends into the exterior covering of the animal bed (200) through an opening (211) so that the length may be anchored onto the animal bed's (200) frame. FIG. 27 shows some additional detail of the buckles (203) and bolsters (201). Where adjacent bolsters are used, the buckles (203) and straps may be arranged so that each bolster (201) may fit onto the animal bed (200). FIGS. 28 and 29 show the use of a sheet (213) on an animal bed (200) having a bolster (201), wherein the (213) has an opening (215) to accommodate the buckle (201) and its related strap/webbing.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

The qualifier “generally,” and similar qualifiers as used in the present case, would be understood by one of ordinary skill in the art to accommodate recognizable attempts to conform a device to the qualified term, which may nevertheless fall short of doing so. This may be because related terms are purely geometric constructs having no real-world equivalent (for example, no sphere is ever perfectly spherical), or there may be other reasons why a given term may be more precise than its real-world equivalent. Variations from geometric, mathematical, and other descriptions are unavoidable due to, among other things, manufacturing tolerances resulting in shape variations, defects and imperfections, non-uniform thermal expansion, and natural wear. Moreover, there exists for every object a level of magnification at which geometric, mathematical, and other precise descriptors fail, due to the nature of matter. One of ordinary skill would thus understand the term “generally” and relationships contemplated herein, regardless of the inclusion of such qualifiers to include a range of variations from the literal geometric, mathematic, or other meaning of the term in view of these and other considerations.

I claim:

1. An animal bed system, the system comprising:
a bed including a frame, a plurality of coils, and an exterior cover,
wherein the exterior cover surrounds the bed, and
wherein the bed includes at least one compartment that passes through the exterior cover, such that the interior of the compartment is accessible from the exterior of the bed.

2. The animal bed system of claim 1, wherein the at least one compartment is accessible through the exterior covering.

3. The animal bed system of claim 2, wherein the compartment further comprises a support portion and a carrier portion,
wherein the support portion is attached to said exterior cover, and
wherein the carrier portion is configured to hold a container at least partially inside of the bed.

4. The animal bed system of claim 3, wherein the attachment between the support portion and the exterior cover is a removable attachment.

5. The animal bed system of claim 3, wherein the carrier portion further comprises a spring.

6. The animal bed system of claim 5, wherein the carrier portion comprises a plastic container having holes therein.

7. The animal bed system of claim 2, further comprising a sheet configured to cover at least a portion of the bed.

8. The animal bed system of claim 7, wherein the bed has a shape like a rectangular prism and having six sides, and the sheet is configured to cover at least five sides of the six sides of the bed.

9. The animal bed system of claim 8, wherein the sheet has at least one sheet opening, wherein the exterior covering has one or more handles, and wherein said at least one sheet opening is configured to allows access to at least one of the one or more the handles.

10. The animal bed system of claim 8, wherein the sheet has at least one sheet opening, and wherein the at least one sheet opening is configured to allows access to the at least one compartment.

11. The animal bed system of claim 1, wherein the container is configured to hold odor-absorbing material.

12. The animal bed system of claim 11, wherein the odor-absorbing material comprises carbon.

13. The animal bed system of claim 11, wherein the odor-absorbing material comprises charcoal.

14. The animal bed system of claim 1, wherein the coils have an hourglass shape, which shape has bulges at each end, and wherein said compartment is formed between the bulges of adjacent coils.

15. The animal bed system of claim 14, wherein the compartment further comprises a support portion and a carrier portion,
wherein the support portion is attached to said exterior cover, and
wherein the carrier portion is configured to hold a container at least partially inside of the bed.

16. The animal bed system of claim 15, wherein the attachment between the support portion and the exterior cover is a removable attachment.

17. The animal bed system of claim 16, wherein the carrier portion further comprises a spring.

18. The animal bed system of claim 17, wherein the container is configured to hold odor-absorbing material.

19. The animal bed system of claim 18, wherein the odor-absorbing material comprises carbon.

20. The animal bed system of claim 18, wherein the odor-absorbing material comprises charcoal.
